(19) United States
(12) Patent Application Publication
(10) Pub. No.: US 2018/0096106 A1
(43) Pub. Date: Apr. 5, 2018

(54) BLOOD MANAGEMENT METHOD, BLOOD MANAGEMENT SERVER APPARATUS, AND BLOOD MANAGEMENT SYSTEM

(71) Applicant: SAMSUNG ELECTRONICS CO., LTD., Suwon-si (KR)

(72) Inventors: Yu Ri SON, Gunpo-si (KR); Sang Bum PARK, Hwaseong-si (KR); Dong Woo KIM, Yongin-si (KR); Byung Chul KIM, Suwon-si (KR); So Lee MOON, Suwon-si (KR); Seo Young SONG, Yongin-si (KR); Keum Yong OH, Yongin-si (KR); Chung Ung KIM, Yongin-si (KR)

(73) Assignee: SAMSUNG ELECTRONICS CO., LTD., Suwon-si (KR)

(21) Appl. No.: 15/665,819

(22) Filed: Aug. 1, 2017

(30) Foreign Application Priority Data
Sep. 30, 2016 (KR) 10-2016-0126674

(51) Int. Cl. G06F 19/00; G06Q 50/22

(52) U.S. Cl. CPC G06F 19/323; G06Q 50/22; G06F 19/3443; G06F 19/3406; G06F 19/327

(57) ABSTRACT

A blood management method, a blood management server apparatus, and a blood management system are provided. The blood management method includes acquiring information about a blood recipient, determining a transfusable blood for the blood recipient based on the blood recipient information, searching for the determined transfusable blood in a blood supplier database (DB), and transmitting a request for use of the transfusable blood or a blood donation request for the transfusable blood according to whether the transfusable blood is found in the blood supplier database (DB).

### CROSS-REFERENCE TO RELATED APPLICATION

This application claims priority from Korean Patent Application No. 10-2016-0126674, filed on Sep. 30, 2016 in the Korean Intellectual Property Office, the disclosure of which is incorporated herein in its entirety by reference.

### BACKGROUND

### 1. Field

Exemplary embodiments of the present disclosure relate to a blood management method, a blood management server apparatus, and a blood management system.

### 2. Description of the Related Art

Blood for transfusion is needed if excessive bleeding caused by a serious accident occurs in animals or humans or blood transfusion caused by surgery is required for animals or humans. Compared to recent development of medical technology, the number of blood donors has sharply decreased due to blood transfusion accidents or concerns about infection, such that the amount of transfusable blood cannot meet demand.

In addition, medical institutions have administrated blood care independently of each other, such that they have difficulty in quickly requesting blood transfusion or blood donation. Therefore, blood management systems for receiving information about blood transfusion objects (i.e., blood recipients) and blood donation objects (i.e., blood donors), performing integrated management of the received information, transmitting the received information about blood transfusion objects (i.e., blood recipients) and blood donation objects (i.e., blood donors) to a terminal device, and displaying the received information about blood transfusion objects (i.e., blood recipients) and blood donation objects (i.e., blood donors) are needed.

### SUMMARY

Therefore, it is an aspect of the present disclosure to provide a blood management method, a blood management server apparatus, and a blood management system, which can acquire information about blood transfusion objects (i.e., blood recipients), determine transfusable blood needed for each blood transfusion object (i.e., each blood recipient), and transmit a blood transfusion request or a blood donation request to blood suppliers or blood donors according to the presence or absence of transfusable blood.

It is another aspect of the present disclosure to provide a blood management method, a blood management server apparatus, and a blood management system, which can acquire information about blood transfusion objects (i.e., blood recipients) and blood donation objects (i.e., blood donors), determine whether blood transfusion or blood donation is possible, and display the acquired information or the determined result using various graphical interfaces.

Additional aspects of the invention will be set forth in part in the description which follows and, in part, will be obvious from the description, or may be learned by practice of the invention.

According to an exemplary embodiment, there is provided a blood management method comprising: acquiring information about a blood recipient; determining transfusable blood for the blood recipient based on the information about the blood recipient; searching for the determined transfusable blood in a blood supplier database; and transmitting a request for use of the transfusable blood to a blood supplier server of at least one searched blood supplier corresponding to the transfusable blood when the transfusable blood is found in the blood supplier database and transmitting a blood donation request to at least one terminal device when the transfusable blood is not found in the blood supplier database.

The information about the blood recipient may comprise at least one of current information and previous information about the blood recipient.

The blood supplier database may comprise blood supplier information about a blood supplier capable of providing the transfusable blood.

The transmitting the request for use of the transfusable blood to the blood supplier server may comprise: receiving location information of a blood supplier from the blood supplier server of the at least one searched blood supplier; determining distance information based on the location information; and determining the blood supplier based on the distance information, and transmitting the request for use of the transfusable blood to a server of the determined blood supplier.

The transmitting the request for use of the transfusable blood to the blood supplier server may comprise: transmitting a request for use of the transfusable blood to the blood supplier server of the at least one blood supplier according to predetermined priority information.

The transmitting the blood donation request to the at least one terminal device may comprise: receiving location information from the at least one terminal device; determining distance information based on t the location information; and transmitting the blood donation request to the at least one terminal device based on the determined distance information.

The transmitting the blood donation request to the at least one terminal device may comprise: transmitting the blood donation request to the at least one terminal device determined according to predetermined priority information.

The current information may comprise at least one of current health status information of the blood recipient, blood type information, species information, and identification (ID) information.

The previous information may comprise at least one of past disease information of the blood recipient, image diagnosis information, vaccination history information, blood test history information, pregnancy history information, blood transfusion history information, blood donation history information, and medicine and medical supplies prescription history information.

The blood supplier information may comprise at least one of location information of the blood supplier, information about an amount of blood held by the blood supplier, contact information, and blood status information.

The blood management method may further comprise: displaying at least one of the acquired blood recipient information, information about the transfusable blood for the blood recipient decided based on the blood recipient information, information about a result of searching for the determined transfusable blood in the blood supplier database, information about a result of requesting use of the transfusable blood, and information about the result of the blood donation request.

The displaying may comprise: arranging at least one of information about the transfusable blood for the blood recipient decided based on the blood recipient information, information about the result of searching for the transfusable blood in the blood supplier database, information about the result of requesting use of the transfusable blood, and information about the result of the blood donation request according to priority information; and displaying the arranged information.

According to another exemplary embodiment, there is provided blood management server apparatus comprising: a receiver configured to receive information about a blood recipient; a storage unit having a target object database and a blood supplier database configured to store the information about the blood recipient; a controller configured to determine transfusable blood for the blood recipient based on the information about the blood recipient, and search for the determined transfusable blood in the blood supplier database; and a transmitter configured to transmit a request for use of the transfusable blood to a blood supplier server of at least one searched blood supplier corresponding to the transfusable blood when the transfusable blood is found in the blood supplier database and transmit a blood donation request to at least one terminal device when the transfusable blood is not found in the blood supplier database.

The information about the blood recipient may comprise at least one of current information and previous information about the blood recipient.

The blood supplier database may comprise blood supplier information about a blood supplier having the transfusable blood.

The current information may comprise at least one of current health status information of the blood recipient, blood type information, species information, and identification (ID) information.

The previous information may comprise at least one of past disease information of the blood recipient, image diagnosis information, vaccination history information, blood test history information, pregnancy history information, blood transfusion history information, blood donation history information, and medicine and medical supplies prescription history information.

The blood supplier information may comprise at least one of location information of the blood supplier, information about an amount of blood held by the blood supplier, contact information, and blood status information.

According to another exemplary embodiment, there is provided a blood management system comprising: a blood management server apparatus configured to receive information about a blood recipient, determine transfusable blood for the blood recipient based on the information about the blood recipient, search for the determined transfusable blood in a blood supplier database, request use of the transfusable blood from a server of the blood supplier by transmitting a request for use of the transfusable blood to the blood supplier server when the transfusable blood is found in the blood supplier database, and request blood donation from at least one terminal device by transmitting a blood donation request to at least one terminal device when the transfusable blood is not found in the blood supplier database; and at least one terminal device configured to display information about at least one of the request for use of the transfusable blood and the blood donation request for the transfusable blood upon receiving the request for use of the transfusable blood and the blood donation request from the blood management server apparatus, or display at least one of information about the blood recipient and information about the blood supplier database.

The information about the blood recipient may comprise at least one of current information and previous information about the blood recipient.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a blood management system according to an exemplary embodiment of the present disclosure.

FIG. 2 is a block diagram illustrating a blood management system according to an embodiment of the present disclosure.

FIG. 3 is a block diagram illustrating a blood management server apparatus according to an embodiment of the present disclosure.

FIG. 4 is a flowchart illustrating a blood management method based on distance information from among blood management methods according to an exemplary embodiment of the present disclosure.

FIG. 5 is a flowchart illustrating a method for determining the presence or absence of blood compatibility from among blood management methods according to an exemplary embodiment of the present disclosure.

FIG. 6 is a flowchart illustrating a method for displaying various kinds of information from among blood management methods according to an exemplary embodiment of the present disclosure.

FIGS. 7 to 13 illustrate exemplary methods for displaying information about a target object and information about a blood supplier received from the blood management server apparatus through a terminal device according to exemplary an embodiment of the present disclosure.

FIGS. 14 to 17 illustrate exemplary methods for displaying information about a blood transfusion request received from the blood management server apparatus through a terminal device according to an exemplary embodiment of the present disclosure.

FIGS. 18 to 20 illustrate exemplary methods for displaying information about a blood donation request received from the blood management server apparatus through a terminal device according to an exemplary embodiment of the present disclosure.

FIGS. 21 and 22 illustrate exemplary methods for displaying information about a blood donation decision result received from the blood management server apparatus through a terminal device according to an exemplary embodiment of the present disclosure.

### DETAILED DESCRIPTION

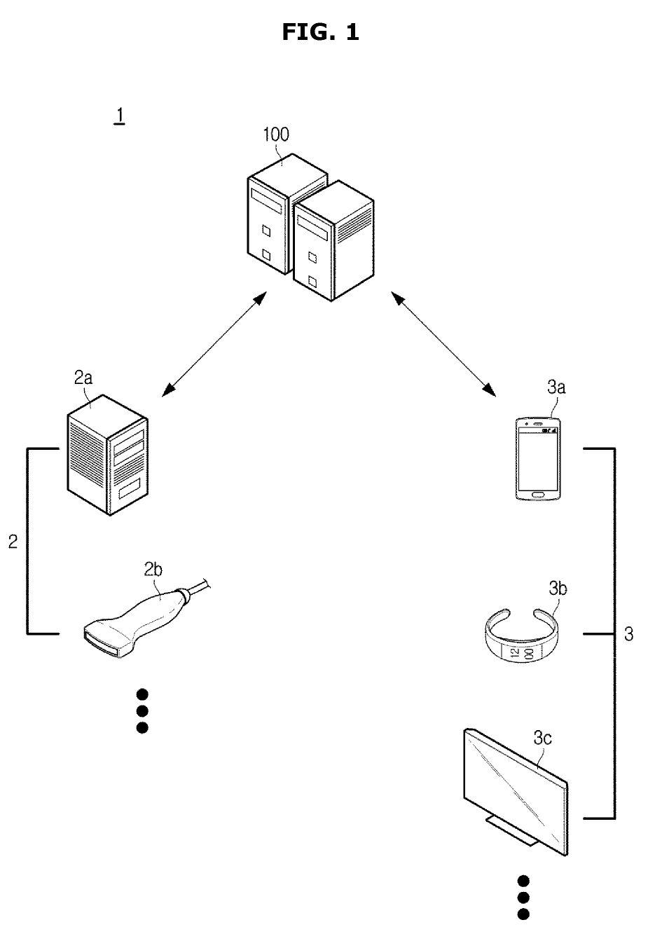

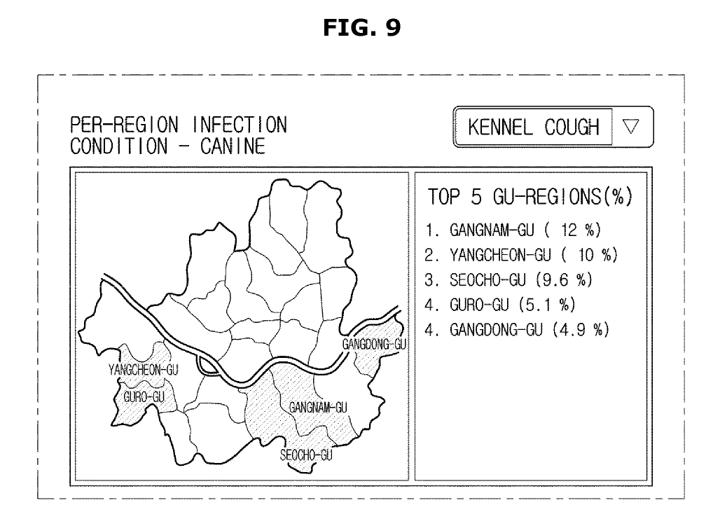

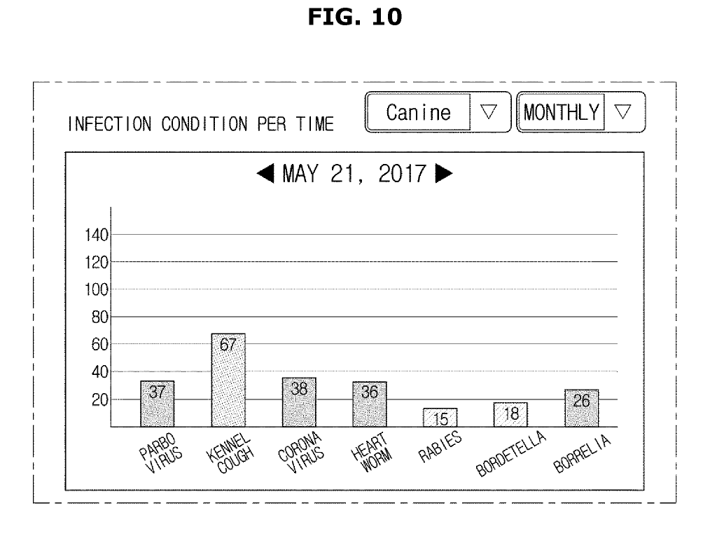

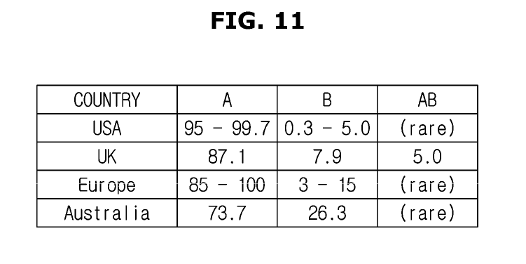

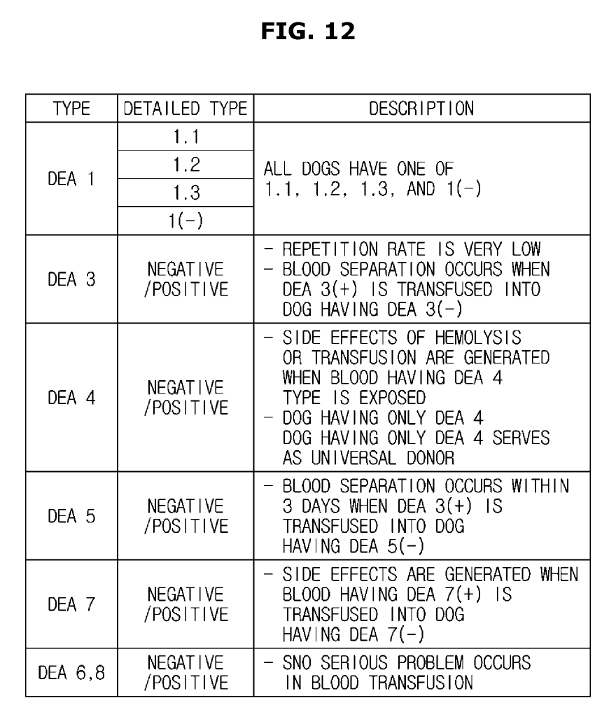

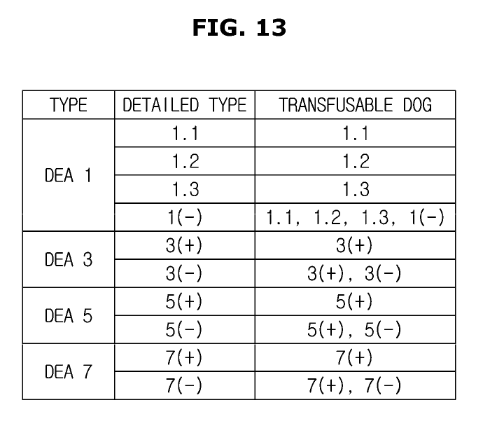

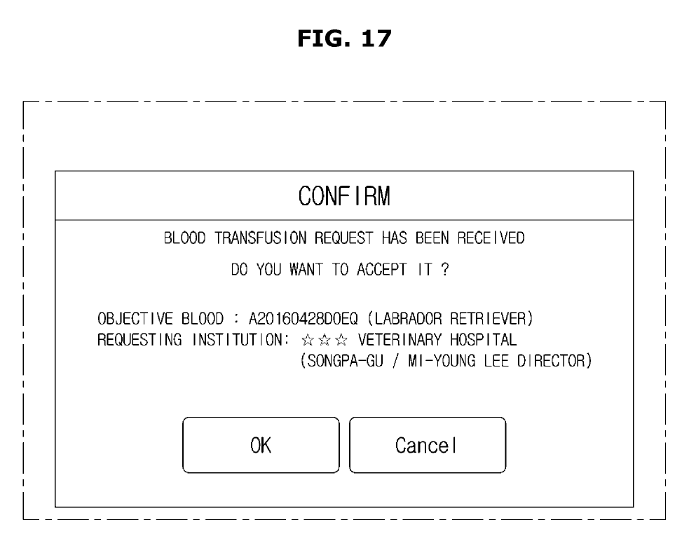

Reference will now be made in detail to the exemplary embodiments of the present disclosure, examples of which are illustrated in the accompanying drawings, wherein like reference numerals refer to like elements throughout. A blood management method, a blood management server apparatus, and a blood management system according to an embodiment of the present disclosure will hereinafter be described with reference to FIGS. 1 to 22.

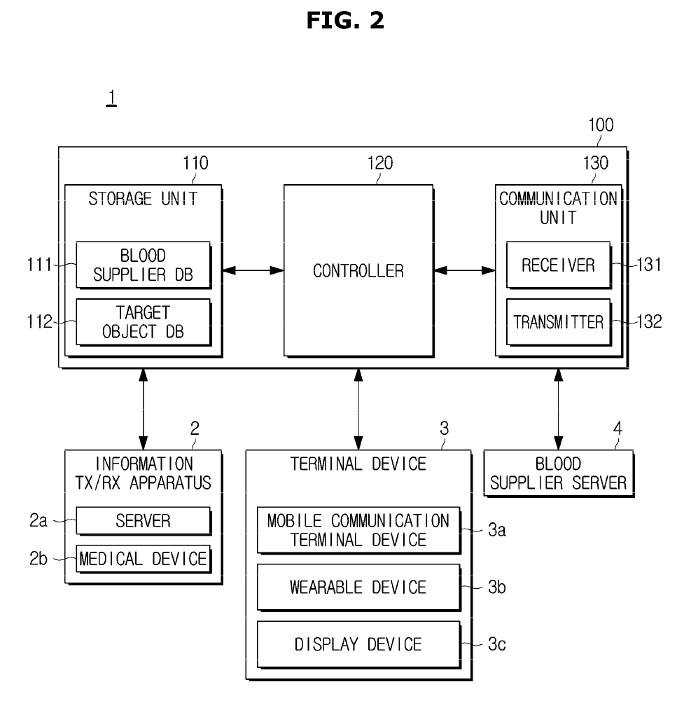

FIG. 1 is a view illustrating a blood management system according to an exemplary embodiment of the present disclosure. FIG. 2 is a block diagram illustrating a blood management system according to an exemplary embodiment of the present disclosure.

Referring to FIGS. 1 and 2, the blood management system 1 may include a blood management server apparatus 100 for storing information received from outside, and transmitting the stored information to at least one terminal device 3, an information transmission/reception (Tx/Rx) apparatus 2 for transmitting and receiving information to and from the blood management server apparatus 100; and at least one terminal device 3 and a blood supplier server 4 for outputting information received from the blood management server apparatus 100, and informing a user of the output information.

FIGS. 1 and 2 illustrate exemplary structures of the blood management system 1. The exemplary structures shown in FIGS. 1 and 2 are not limited thereto, and may include many more constituent elements without departing from the scope or spirit of the present disclosure.

The information Tx/Rx apparatus 2 may acquire at least one of information about a target object and information about a blood supplier from outside, and may transmit the acquired target object information and the acquired blood supplier information to the blood management server apparatus 100.

In this case, the target object may denote an animal or person to serve as a blood recipient or a blood donor. In other words, the target object may be all kinds of living things capable of serving as blood recipients or blood donors. The term “target object” may be at least one of a person and animal.

In addition, target object information may include various kinds of information needed to manage blood of a target object (e.g., person or animal). For example, the target object information may include target object identification (ID) information (e.g., name, age, gender, weight, height, etc.), blood information (e.g., blood group, blood-gathering date, etc.), location information, health information, blood grouping test resultant information, decision information for determining whether a blood transfusion or a blood donation is possible, resultant information about a blood transfusion request or a blood donation request, electronic medical record (EMR) information, terminal device information of a target object, information as to whether a blood transfusion between target objects is possible, blood type information of a target objet, blood donation available condition information of a target object, health information of a target object (e.g., disease information, infection information, etc.), and the like. In addition, target object information may include information about a blood recipient and information about a blood donor.

In addition, a blood supplier may denote a blood supply center, a hospital, a country, etc. having various blood types. In addition, blood supplier information may include a total amount of blood held by the blood supplier, categories of blood held by the blood supplier, location information, terminal device information, server information, blood storage state information, etc.

The information Tx/Rx apparatus 2 may acquire at least one of target object information and blood supplier information from outside, and may transmit at least one of the acquired target object information and the acquired blood supplier information to the blood management server apparatus 100. In addition, the information Tx/Rx apparatus 2 may include a server 2a of each hospital or institution and a medical device 2b capable of communicating with the server 2a. The information Tx/Rx apparatus 2 may include a computer or the like configured to serve as a remote management system (RMS). The information Tx/Rx apparatus 2 may include a biological injection RFID chip storing animal identification (ID) information based on an animal registration system. Here, the biological injection RFID chip may be inserted into animals.

However, the above-mentioned structure is merely an example of the information Tx/Rx apparatus 2. The information Tx/Rx apparatus 2 may be any kind of device capable of transmitting and receiving at least one of target object information and blood supplier information to and from the blood management server apparatus 100. Therefore, the information Tx/Rx apparatus 2 may serve as an input unit configured to input various kinds of information to the blood management server apparatus 100. That is, the information Tx/Rx apparatus may correspond to an input unit of the blood management system 100.

The server 2a may include electronic medical record (EMR) data stored in hospitals or institutions.

The EMR data may denote target object information held by hospitals. In more detail, the EMR data may include physical information of a target object, health information of a target object, infectious disease history information, image diagnosis records, vaccination history, blood test history, pregnancy history, blood transfusion and blood donation history, medicine and medical supplies prescription history, stored blood information, information about a transfusable object (i.e., a blood recipient), information about a blood donation object (i.e., a blood donor), etc.

The server 2a may transmit EMR data to the blood management server apparatus 100 corresponding to a central server. If new EMR data is input to the server 2a, the server 2a can update, accumulate, and store the received EMR data. The server 2a may transmit the updated EMR data to the blood management server apparatus 100. The server 2a may transmit EMR data to the blood management server apparatus 100 in real time or at intervals of a predetermined time.

The server 2a may share EMR data of the target object with a plurality of computers of hospitals or institutions. The server 2a may transmit EMR data upon receiving a request from the blood management server apparatus 100.

The medical device 2b may include a communication module such that the medical device 2b can communicate with the blood management server apparatus 100. The medical device 2b may acquire information about the target object, and may transmit the acquired information to the blood management server apparatus 100. For example, the medical device 2b may be any of an ultrasonic imaging apparatus, a magnetic resonance imaging (MRI) apparatus, a computed tomography (CT) apparatus, a blood testing apparatus, etc.

The blood management server apparatus 100 may store at least one of target object information and blood supplier information received from the transmission apparatus 2 over a wireless communication network or a wired communication network, and may transmit the stored information to at least one terminal device 3.

The blood management server apparatus 100 may search for the stored target object information, and may transmit the result information to at least one terminal device 3 as necessary.

The blood management server apparatus 100 may transmit information about the result as to whether a target object decided on the basis of information stored in the storage unit 110 accepts or rejects a blood donation to at least one terminal device 3.

The blood management server apparatus 100 includes at least one processor. The blood management server apparatus 100 may transmit at least one of the stored target object information and the stored blood supplier information, and may determine whether the stored target object information and the stored blood supplier information correspond to a predetermined condition.

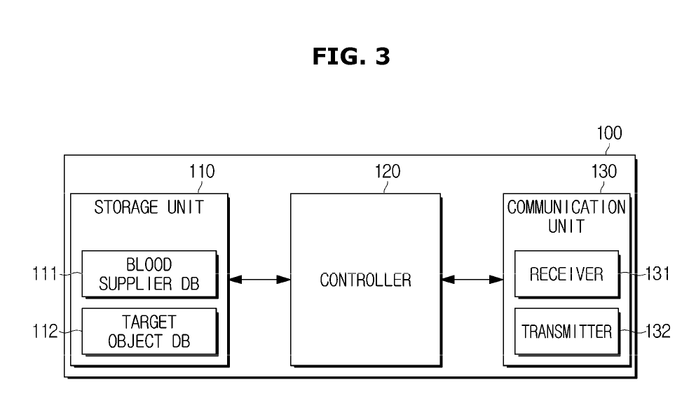

The blood management server apparatus 100 may determine whether at least one of the stored target object information and the blood supplier information corresponds to the predetermined condition, and may transmit the determined result to at least one terminal device 3. The blood management server apparatus 100 will hereinafter be described with reference to FIG. 3.

The terminal device 3 may include a communication module (not shown) and a display (not shown), and may further include an electronic device capable of receiving information from the blood management server apparatus 100 and displaying the received information.

The terminal device 3 may include at least one of a mobile communication terminal device 3a, a wearable device 3b, and a display device 3c. In addition, the terminal device 3 may include computers of hospitals or institutions. In addition, the terminal device 3 may include an input unit (not shown), and may transmit a transmission request of at least one of target object information and blood supplier information to the blood management server apparatus 100.

The terminal device 3 may include a communication module (not shown) capable of communicating with the blood management server apparatus 100. The terminal device 3 may transmit and receive at least one of target object information and blood supplier information to and from the blood management server apparatus 100. In addition, the terminal device 3 may include a display (not shown) such that the display may display information received from the blood management server apparatus 100 thereon.

In more detail, the terminal device 3 may receive at least one of target object information and blood supplier information from the blood management server apparatus 100, and may display the received information thereon. In addition, the terminal device 3 may receive at least one of the result of searching for target object information and the decision result as to whether a blood donation of the target object is accepted or denied from the blood management server apparatus 100, and may display the received result thereon.

However, the terminal device 3 is only an exemplary structure for explaining the blood management server apparatus 100, and is not limited thereto. Therefore, the terminal device 3 may include an electronic device, which can communicate with the blood management server apparatus 100 and can display at least one of target object information and blood supplier information received from the blood management server apparatus 100.

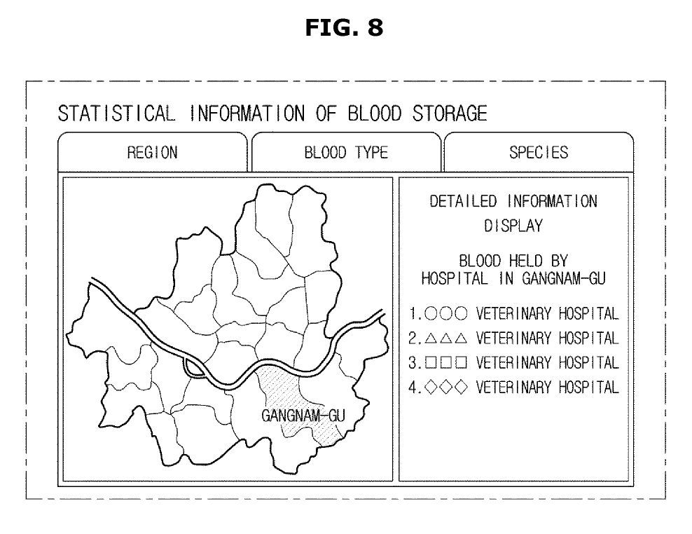

The terminal device 3 may display at least one of a transfusable blood usage request and a blood donation request received from the blood management server apparatus 100, or may display at least one of blood recipient (i.e., blood transfusion object) information and blood supplier database (DB) information 111 using various graphical interfaces. A detailed description thereof will hereinafter be given with reference to FIGS. 8 to 22.

The blood supplier server 4 may denote a server of a hospital or institution corresponding to a blood supplier. The blood supplier server 4 may transmit and receive at least one of target object information and blood supplier information to and from the blood management server apparatus 100. In addition, the blood supplier server 4 may transmit at least one of location information of the blood supplier and transfusable blood storage state information to the blood management server apparatus 100.

Constituent elements of the blood management system 1 have been described above, such that the blood management system 1 can be constructed using the above constituent elements. That is, according to an exemplary embodiment, the blood management system 1 may interconnect the server 2a of the hospital or institution, the blood management server apparatus 100, and the terminal device 3 over a single network, such that target object information and blood supplier information can be communicated among the server 2a, the blood management server apparatus 100, and the terminal device 3.

For instance, blood transfusion or blood donation may not be activated in the case of animal blood management, such that the blood transfusion or blood donation may have been manually administrated by institutions or hospitals for animals using independent programs or handwritten systems.

Therefore, the blood management system 1 may share blood storage information of hospitals or institutions, target object information, target object location information, etc., such that the blood management system 1 may transmit a request of using transfusable blood to such hospitals or institutions or may transmit a blood donation request to a blood donor.

The blood management system 1 may determine whether blood donation of the blood donor is possible using the stored information.

The blood management system 1 may perform integrated management of target object information and blood supplier information. As a result, when there arises an emergency situation in which blood transfusion for a blood recipient is needed, the blood management system 1 can more quickly and more conveniently request a blood donation associated with transfusable blood. In addition, the blood management system 1 may share, control, receive, and transmit blood management information between several electronic devices configured to communicate with each other through the blood management server apparatus 100 corresponding to the central server. As a result, all kinds of blood information can be integrally managed and shared by a single central server, such that necessary blood can be more quickly supplied to patients or animals.

FIG. 3 is a block diagram illustrating the blood management server apparatus according to an exemplary embodiment of the present disclosure.

Referring to FIG. 3, the blood management server apparatus 100 may include a storage unit 110 configured to store information received from an external part, a controller 120 configured to search for information corresponding to a predetermined condition based on the stored information, and a communication unit 130 configured to communicate with the external part.

The storage unit 110 may include a blood supplier DB 111 configured to store blood supplier information received from outside, and a target object DB 112 configured to store target object information.

In this case, the information received from outside may denote target object information and blood supplier information contained in EMR data received through the server 2a of each hospital or institution. In addition, the information received from outside may denote target object information and blood supplier information received through the medical device 2b.

In this case, the storage unit 110 may determine whether the received information is blood supplier information or target object information, may classify the determined information, and may respectively store the blood supplier information and the target object information in the blood supplier DB 111 and the target object DB 112.

The storage unit 110 may be implemented as a non-volatile memory device such as a read only memory (ROM), a programmable read only memory (PROM), an erasable programmable read only memory (EPROM), or a flash memory, a volatile memory device such as a random access memory (RAM), or a storage medium such as a hard disk drive (HDD) or CD-ROM, without being limited thereto. The storage unit 110 may be a memory that is implemented as a separate chip independent of the controller 120, or may be implemented as a processor and a single chip. In addition, the storage unit 110 may store programs for processing or controlling the controller 120, and may temporarily store input/output (I/O) data.

The blood supplier DB 111 may store information about blood suppliers having transfusable blood. In more detail, blood supplier information may include at least one of location information of institutions or hospitals acting as blood suppliers, contact information of institutions or hospitals, server information of institutions or hospitals, terminal device information of institution or hospitals, information about the amount of blood held by institutions or hospitals, and blood state information. The blood supplier DB 111 may periodically or in real-time update information about the received blood supplier, and may store the updated information therein.

The target object DB 112 may store target object information received from outside. The target object information may include blood recipient information and blood donor information. The target object DB 112 may periodically or in real-time update blood recipient information and blood donor information, and may store the updated information.

Blood recipient information and blood donor information may respectively denote information about a blood transfusion object and information about a blood donation object. The blood-recipient/blood-donor information may include blood-recipient/blood-donor ID information (e.g., physical information such as name, age, gender, weight, height, etc.) of a blood recipient or blood donor, terminal device information, location information, blood type information, ID information, species information (in case of animals), health information (e.g., disease history, image diagnosis record, vaccination history, blood test history, pregnancy history, blood transfusion and blood donation history, medicine and medical supplies prescription history, etc.).

In addition, blood-recipient/blood-donor information may include at least one of current information of a blood recipient or blood donor and previous information about the blood recipient or blood donor.

The blood-recipient/blood-donor information may include at least one of current health state information of a blood recipient or blood donor, blood type information, species information (in case of animals), and ID information (e.g., physical information such as name, gender, age, weight, height, etc.)

The current blood-recipient/blood-donor information may be received from the information Tx/Rx apparatus 2.

In more detail, according to a method for controlling the blood server apparatus 100 to receive current blood-recipient/blood-donor information from the information Tx/Rx apparatus 2, a user may input current blood-recipient/blood-donor information using the input unit (not shown) of the medical device 2b or the terminal device 3.

When the above method is applied to animals, the biological injection RFID inserted into a body of the corresponding animal is recognized as a reader such that the user can input current blood-recipient/blood-donor information.

The current blood-recipient/blood-donor information entered by the user may be stored in the server 2a of institutions or hospitals.

Finally, the server 2a may transmit the stored current blood-recipient/blood-donor information to the storage unit 110 of the blood management server apparatus 100. Through the above-mentioned processing, the blood management server apparatus 100 may receive current blood-recipient/blood-donor information from the information Tx/Rx apparatus 2.

Previous blood-recipient/blood-donor information may denote pre-acquired past information instead of the current blood-recipient/blood-donor information. That is, the previous blood-recipient/blood-donor information may denote information acquired when a blood recipient or a blood donor is examined in each institution or hospital in the past. In more detail, previous blood-recipient/blood-donor information may include at least one of past disease history of the blood recipient or blood donor, image diagnosis information, vaccination history, blood test history, pregnancy history, blood transfusion history, blood donation history, and medicine and medical supplies prescription history.

Therefore, the blood-recipient/blood-donor information may be stored in EMR data of the server 2b of each institution or hospital, and may be stored in the target object DB 111 of the blood management server apparatus 100.

The controller 120 may be implemented as an algorithm for controlling constituent elements contained in the blood management server apparatus 100, a memory (not shown) for storing data regarding a program implementing the algorithm, and a processor (not shown) for performing the above-mentioned operation using data stored in the memory. In this case, the memory and the processor may be implemented as different chips as necessary. Alternatively, the memory and the processor may be implemented as a single chip.

In addition, the controller 120 may determine transfusable blood for a blood recipient on the basis of blood recipient information received from outside. For example, the controller 120 may determine that transfusable blood for a blood recipient is B RH-negative (RH−) blood on the basis of blood recipient information (e.g., blood type information) received from outside.

In addition, the controller 120 may determine whether a blood donation of a blood donor is possible on the basis of not only current blood donor information received from outside but also previous blood donor information stored in the storage unit 110. The controller 120 may control the communication unit 130 to transmit the determined resultant information to the terminal device 3.

For example, although the received current target object information indicates that a blood donor has a health state appropriate for blood donation, if it is not long since the most recent blood donation of the blood donor, blood donation can be considered impossible because previous target object information includes vaccination history, past disease history, medical examination history, blood donation history, pregnancy/non-pregnancy state information, etc. That is, if a predetermined time has not elapsed since the most recent blood donation of the blood donor, blood donation can be considered impossible.

In addition, the controller 120 may search for the determined transfusable blood in the blood supplier DB 111. In more detail, the controller 120 may search for the presence or absence of transfusable blood information in the blood supplier DB 111. The blood supplier DB 111 may include information about the blood supplier capable of providing transfusable blood. Therefore, the controller 120 may search for transfusable blood storage state information of a blood supplier in the blood supplier information, such that the controller 120 may search for the presence or absence of the transfusable blood storage state information in the blood supplier DB 111. The controller 120 may control the communication unit 130 to transmit the search result information to the terminal device 3.

According to an exemplary embodiment in FIG. 2, the communication unit 130 may include one or more constituent elements capable of communicating with the information Tx/Rx apparatus 2, the terminal device 3, and the blood supplier 4. For example, the communication unit 130 may include at least one of a short-range communication module, a wired communication module, and a wireless communication module.

The short-range communication module may include a variety of short-range communication modules for transmitting/receiving signals over a wireless communication network over a short distance, for example, a Bluetooth module, an infrared (IR) communication module, a Wireless Local Area Network (WLAN) communication module, a Near Field Communication (NFC) communication module, a ZigBee communication module, etc.

The wired communication module may include not only various wired communication modules, for example, a Local Area Network (LAN) module, a Wide Area Network (WAN) module, a Value Added Network (VAN) module, etc., but also various cable communication modules, for example, Universal Serial Bus (USB), High Definition Multimedia Interface (HDMI), Digital Visual Interface (DVI), RS-232 (recommended standard232), power line communication, a Plain Old Telephone Service (POTS), etc.

The wireless communication module may include a Wi-Fi module and a Wireless broadband (WiBro) module, and may further include a wireless communication module for supporting various wireless communication schemes, for example, Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), etc.

The wireless communication module may include a wireless communication interface comprised of an antenna and a transmitter configured to receive target object information and blood supplier information. The wireless communication module may further include a signal conversion module associated with target object information and blood supplier information. Here, the signal conversion module may be configured to modulate an analog-type radio signal received through the wireless communication interface into a digital control signal.

The wireless communication module may include a wireless communication interface comprised of an antenna and a receiver configured to receive target object information and blood supplier information. The wireless communication module may further include a signal conversion module associated with target object information and blood supplier information. Here, the signal conversion module may be configured to demodulate an analog-type radio signal received through the wireless communication interface into a digital control signal.

The communication unit 130 may include a receiver 131 configured to acquire target object information from outside, and a transmitter 132 configured to transmit a request for using transfusable blood or a request for blood donation.

The receiver 131 may receive at least one of target object information and blood supplier information from at least one of the server 2a and the medical device 2b.

If the controller 120 searches for transfusable blood in the blood supplier DB 111, the transmitter 132 may send a request for use of the transfusable blood to the blood supplier server 4. In addition, if the controller 120 does not search for transfusable blood in the blood supplier DB 111, the transmitter 132 may send a blood donation request to at least one terminal device 3.

For example, according to the result of information search in the blood supplier DB 111, if it is determined that B RH-negative (RH−) blood corresponding to a transfusable blood is present in a medical institution C, the presence of transfusable blood is decided, such that a request for use of B RH− blood can be transmitted to the server of the medical institution C. However, according to the result of information search in the blood supplier DB 111, if B RH− blood corresponding to the transfusable blood is not found in any institutions or hospitals, the absence of the transfusable blood is decided. As a result, information stored in the target object DB 112 is searched, such that information about a target object having B RH- blood corresponding to transfusable blood is acquired, and a blood donation request can be transmitted to at least one terminal device 3 of the target object. For example, if the target object is an animal, a blood donation request can be sent to a terminal device 3 of an animal guardian.

The terminal device 3 may include at least one of a mobile communication terminal device 3a, a wearable device 3b, and a display device 3c.

The terminal device 3 may include a communication module (not shown) and a display (not shown).

The display of the terminal device 3 may be implemented by any one of a Cathode Ray Tube (CRT), a Digital Light Processing (DLP) panel, a Plasma Display Panel (PDP), a Liquid Crystal Display (LCD) panel, an Electro Luminescence (EL) panel, an Electrophoretic Display (EPD) panel, an Electrochromic Display (ECD) panel, a Light Emitting Diode (LED) panel, and an Organic Light Emitting Diode (OLED) panel, without being limited thereto.

Therefore, the terminal device 3 may receive information from the blood management server apparatus 100, and may display the received information. Such information may include at least one of target object information and blood supplier information.

The terminal device 3 may display information about the request for use of a transfusable blood received from the blood management server apparatus 100. In addition, the terminal device 3 may display information about a blood donation request of a blood donor received from the blood management server apparatus 100.

The terminal device 3 may receive information about the decision result as to whether a blood donation of the target object is accepted or denied from the blood management server apparatus 100, and may display the received information thereon.

The exemplary embodiments for displaying on the terminal device 3 will hereinafter be described with reference to FIGS. 8 to 22.

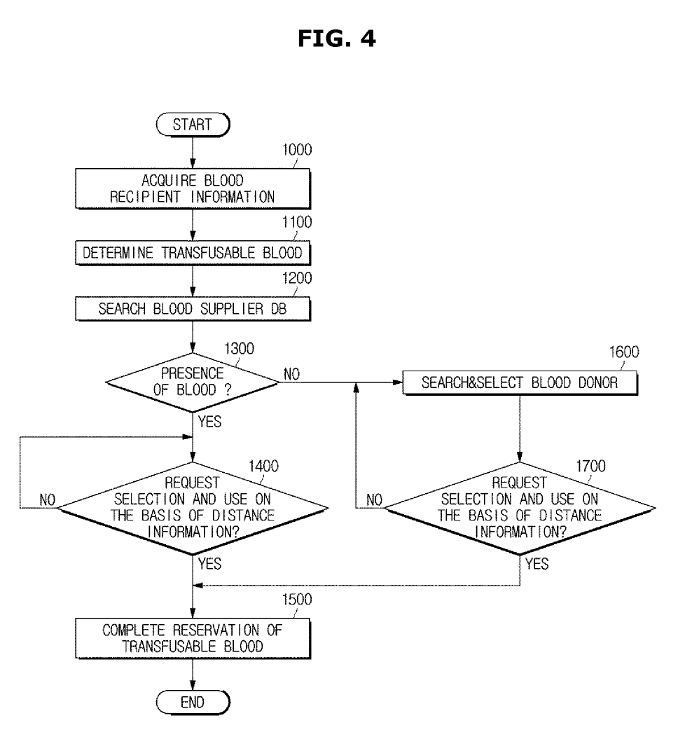

The above-mentioned description provides a method for operating the blood management server apparatus 100 on the basis of constituent elements of the blood management server apparatus 100. FIG. 4 is a flowchart illustrating a blood management method based on distance information from among blood management methods according to an exemplary embodiment of the present disclosure.

A method for transmitting a blood transfusion request or a blood donation request to the terminal device 3 using the blood management server apparatus 100 from among blood management methods will hereinafter be described with reference to FIG. 4 according to an exemplary embodiment.

The receiver 131 of the blood management server apparatus 100 may acquire blood recipient information from outside (1000). For example, the receiver 131 may receive information of a blood recipient for whom a blood transfusion is needed from EMR stored in the server 2b of a medical institution and hospital. In addition, when blood recipient information is entered through the medical device 2b, the receiver 131 may receive blood recipient information over a wireless communication network or a wired communication network. In this case, the blood recipient information may include current information and past information (or previous information) of the blood recipient.

If the controller 131 of the blood management server apparatus 100 receives a command for requesting decision of transfusable blood for a blood recipient, the controller 131 may determine transfusable blood for the blood recipient on the basis of current information and previous information of a blood recipient obtained through the receiver 131 (1100).

For example, assuming that there is a dog requiring emergency surgery, the blood management server apparatus 100 receives not only information (i.e., current information) needed for blood transfusion (e.g., current health state information, blood type information, etc.) entered by the input unit of the medical device 2b or the terminal device 3, but also past information (i.e., previous information) recognized through EMR received from the server 2a of each institution or hospital (e.g., information as to whether a blood transfusion for the dog has been conducted in the past, information as to whether antibodies have been generated in the past, past pregnancy record, past disease history, etc.). If it is determined by the blood management server apparatus 100 that the dog can only receive DEA 1.1 (i.e., one type of dog blood) on the basis of the received information, the blood management server apparatus 100 may determine a transfusable blood type to be DEA 1.1 (one type of dog blood).

The controller 131 of the blood management server apparatus 100 may search for the presence or absence of information about the decided transfusable blood in the blood supplier DB 111 (1200).

For example, assuming that a blood needed for dog transfusion is a DEA 1.1 blood from among various dog blood types, the blood management server apparatus 100 can search for the presence or absence of blood information in the blood supplier DB 111.

When the controller 130 of the blood management server apparatus 100 searches for transfusable blood information in the blood supplier DB 111, if information about the transfusable blood is found in the blood supplier DB 111, the controller 130 may determine the presence of the transfusable blood (‘Yes’ in 1300). In this case, the transmitter 132 of the blood management server apparatus 100 may transmit a request to use a transfusable blood to the server 4 of at least one blood supplier corresponding to the transfusable blood.

The operation for transmitting the request for use of the transfusable blood to the blood supplier server 4 may include receiving location information of the blood supplier from the server 4 of at least one blood supplier, determining distance information on the basis of the location information and determining a blood supplier on the basis of the distance information, and transmitting a request for use of the transfusable blood to the server 4 of the determined blood supplier.

In this case, the user requests that the nearest blood supplier having transfusable blood send information as to whether blood transfusion is possible. If a request for selecting and using the transfusable blood is received by the receiver 131 of the blood management server apparatus 100 on the basis of distance information, the controller 130 may search for information stored in the blood supplier DB 111, and may transmit a request for receiving location information of the blood supplier to the server 4 of at least one blood supplier having transfusable blood through the transmitter 132. In this case, the receiver 131 may receive location information of the blood supplier from the server 4 of at least one blood supplier having transfuable blood.

The controller 130 may determine distance information indicating how far the transfusable blood is from the blood recipient on the basis of the received blood supplier location information.

The controller 130 may determine the blood supplier on the basis of the distance information, and the transmitter 132 may transmit a request for use of transfusable blood to the server 4 of the determined blood supplier (‘Yes’ in 1400).

For example, it is assumed that a search request for transfusable blood is transferred to the blood management server apparatus 100 on the basis of the location nearest the blood recipient. In this case, when the blood management server apparatus 100 searches for information stored in the blood supplier DB 111, if there is a plurality of blood suppliers having transfusable blood, the blood management server apparatus 100 may receive blood supplier location information from the server 4 of the plurality of blood suppliers.

The blood management server apparatus 100 may determine distance information indicating the distance between the blood supplier and the blood recipient on the basis of the received blood supplier location information and the blood recipient location information.

The blood management server apparatus 100 may determine one of the plurality of blood suppliers found on the basis of the decided distance information, and may transmit a request for use of the transfusable blood to the server 4 of the decided blood supplier.

In response to the request for use of transfusable blood from the blood management server apparatus 100, if an acceptance message is received from the server 4 of the decided blood supplier through the receiver 131, reservation of the transfusable blood is completed (1500).

In response to the request for use of transfusable blood from the blood management server apparatus 100, if a denial message is received from the server 4 of the decided blood supplier through the receiver 131, the transmitter 132 may transmit the request for use of transfusable blood to the server 4 of another blood supplier having the transfusable blood, instead of to the server 4 of the denied blood supplier (‘No’ in 1400).

When the controller 130 of the blood management server apparatus 100 searches for transfusable blood information in the blood supplier DB 111, if the transfusable blood information is not found in the blood supplier DB 111, the absence of the transfusable blood is determined (‘No’ in 1300).

In this case, if the user inputs a request for searching and selecting a target object capable of donating blood to the blood management server apparatus 100 (1600), the controller 130 may search for transfusable blood and information about a blood donor having the transfusable blood using at least one of the blood supplier DB 111 and the target object DB 112, and may transmit a request for blood donation to the found blood donor.

In this case, the user may request information about possibility or impossibility of blood donation from a blood donor (i.e., a blood donation requesting object) having transfusable blood, located closest to the blood recipient (i.e., a person or animal in need of blood transfusion).

If the receiver 131 of the blood management server apparatus 100 receives the request for selection and blood donation on the basis of distance information according to the request of the user, the controller 130 may search for information contained in the target object DB 112.

According to the search result of the controller 130, if it is determined that information about the blood donor having transfusable blood is present in information stored in the target object DB 112, a blood donation request may be sent to at least one terminal device 3 through the transmitter 132.

The controller 130 may request reception of location information from at least one terminal device 3 of a target object having transfusable blood on the basis of blood donor information. However, if a target object having transfusable blood is an animal, the controller 130 may request reception of location information from at least one terminal device 3 of a guardian of a target object having transfusable blood.

In this case, the receiver 131 may receive location information from at least one terminal device 3. The controller 130 may determine distance information indicating how far the transfusable blood is from the blood recipient on the basis of the received location information of at least one terminal device 3.

The controller 130 may determine at least one terminal device 3 of the blood donor searched on the basis of distance information, and may request blood donation of transfusable blood from the at least one terminal device 3 of the decided blood donor through the transmitter 132 (‘Yes’ in 1700).

That is, the operation for requesting blood donation from the at least one terminal device 3 may include receiving location information from the at least one terminal device 3, determining distance information on the basis of the location information, and requesting blood donation from the at least one terminal device 3 on the basis of the distance information.

In response to a blood donation request for transfusable blood from the blood management server apparatus 100, if an acceptance message is received from the at least one terminal device 3 through the receiver 131, reservation of the transfusable blood is completed (1500).

In response to the blood donation request for transfusable blood from the blood management server apparatus 100, if a denial message is received from at least one terminal device 3 through the receiver 131, the transmitter 132 may transmit a request for use of transfusable blood to at least one another terminal device 3 other than the denied terminal device (‘No’ in 1700).

In an exemplary embodiment, since the constituent elements (i.e., the information Tx/Rx device 2, the blood management server apparatus 100, and the terminal device 3) of the blood management system 1 may be interconnected over a single network, the constituent elements of the blood management system 1 can communicate with each other over the network, such that the above-mentioned location information can be communicated among the constituent elements of the blood management system 1, and the blood management server apparatus 100 can acquire the location information upon receiving GPS information from the server 2b or the terminal device 3.

As can be seen from FIG. 4, the above-mentioned process illustrates an exemplary case in which the distance information is predetermined priority information. However, the predetermined priority information may be previously established in different ways according to user intention according to another exemplary embodiment.

In other words, the operation for transmitting the request for use of transfusable blood to the blood supplier server 4 may include transmitting the request for use of the transfusable blood to the at least one blood supplier decided according to the predetermined priority information. In addition, the operation for requesting blood donation from at least one terminal device 3 may include requesting blood donation from at least one terminal device decided according to the predetermined priority information.

The operation for requesting blood donation from the at least one terminal device 3 may include requesting blood donation from the at least one terminal device 3 decided on the basis of the predetermined priority information.

That is, the predetermined priority information may denote the order of requests to be used in the case in which the blood management server apparatus 100 requests blood transfusion or blood donation from the server 4 of the blood supplier or at least one terminal 3.

As can be seen from FIG. 4, the predetermined priority information may include information about the distance between a blood recipient and a blood supplier, information about the distance between one or more terminal devices 3 of the blood recipient and the blood donor, species similarity information (in case of animals), blood compatibility information of the blood recipient and the blood donor, the amount of blood held by the blood supplier, blood transfusion compatibility information, the most recent blood donation date, gender information, age information, obesity index information, pregnancy/non-pregnancy state information, etc.

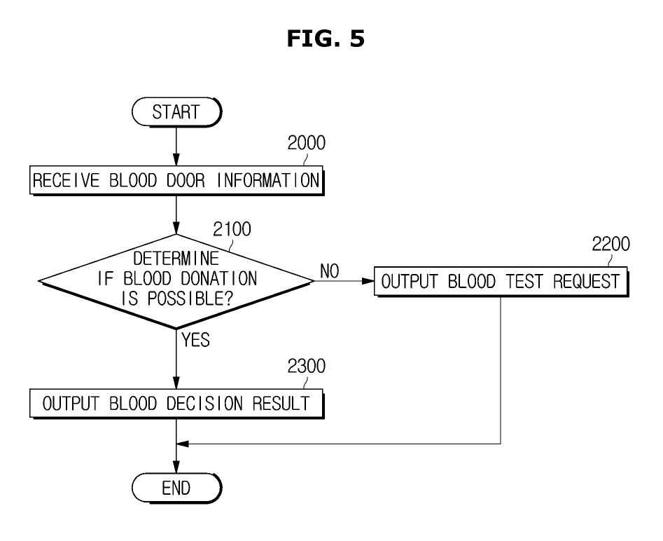

FIG. 5 is a flowchart illustrating a method for determining the presence or absence of blood compatibility from among blood management methods according to an exemplary embodiment of the present disclosure.

Referring to FIG. 5, the blood management method and the blood management server apparatus 100 according another exemplary embodiment of the present disclosure can determine whether blood donation of the blood donor is possible on the basis of the received blood donor information.

The blood management server apparatus 100 may receive information about the blood donor (person or animal scheduled to donate blood) from the information Tx/Rx apparatus 2 (2000).

The blood donor information may include current blood donor information and previous (past) blood donor information.

Upon receiving the blood donor information, the controller 130 of the blood management server apparatus 100 may determine whether blood donation is possible using at least one of the current blood donor information received from outside and the past information stored in the target object DB 112 (2100).

The blood management server apparatus 100 may transmit the blood donation decision result to the terminal device 3. In more detail, according to the decision result of the blood management server apparatus 100, if information as to whether blood donation is possible can be determined, information about the blood donation decision result can be transmitted to the terminal device 3 (‘Yes’ in 2100).

In this case, the terminal device 3 may output information about the blood donation decision result received from the blood management server apparatus 100 (2200).

According to the decision result of the blood management server apparatus 100, if it is impossible to perform the operation for determining whether blood donation is possible (‘No’ in 2100), the blood management server apparatus 100 may transmit information about a blood test request to the terminal device 3. The terminal device 3 may output information about the blood test request received from the blood management server apparatus 100 (2300).

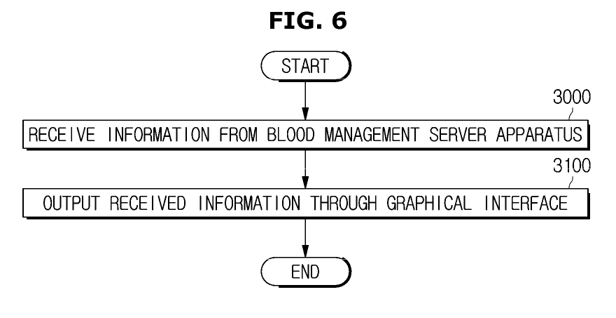

FIG. 6 is a flowchart illustrating a method for displaying various kinds of information from among blood management methods according to an exemplary embodiment of the present disclosure.

Referring to FIG. 6, at least one terminal device 3 of the blood management system 1 according to another exemplary embodiment of the blood management method may receive a plurality of pieces of information from the blood management server apparatus 100 (3000).

At least one terminal device 3 of the blood management system 1 may output the received pieces of information using a graphical interface (3100).

The plurality of pieces of information may include at least one of target object information and blood supplier information.

In more detail, the terminal device 3 may receive at least one of blood recipient information, transfusable blood information for the blood recipient decided on the basis of the blood recipient information, information about the result for searching for transfusable blood in the blood supplier DB 111, information about the result for searching for transfusable blood in the blood supplier DB 111, information about the result for requesting use of transfusable blood, and information about the blood donation requesting result from the blood management server apparatus 100, and may output the received information using various graphical interfaces.

The terminal device 3 may arrange at least one of transfusable blood information for a blood recipient decided on the basis of information received from the blood management server apparatus 100, information about the results of searching for the decided transfusable blood in the blood supplier DB 111, information about the results of requesting use of the transfusable blood, and information about the blood donation request result according to priority information, and may display the arrangement result using various graphical interfaces.

The terminal device 3 may receive information about the result of acceptance or denial of blood donation of a blood donor, system screen information for the blood management method, statistical information about blood held by the blood supplier, disease infection status information for each region of a target object, disease infection status information for each time of a target object, blood type distribution information for each country of a target object, acceptance/denial information of blood donation between target objects, priority setting screen information about blood transfusion use request and blood donation use request, and information about the results of searching for transfusable blood from the blood management server apparatus 100, and may display the received information.

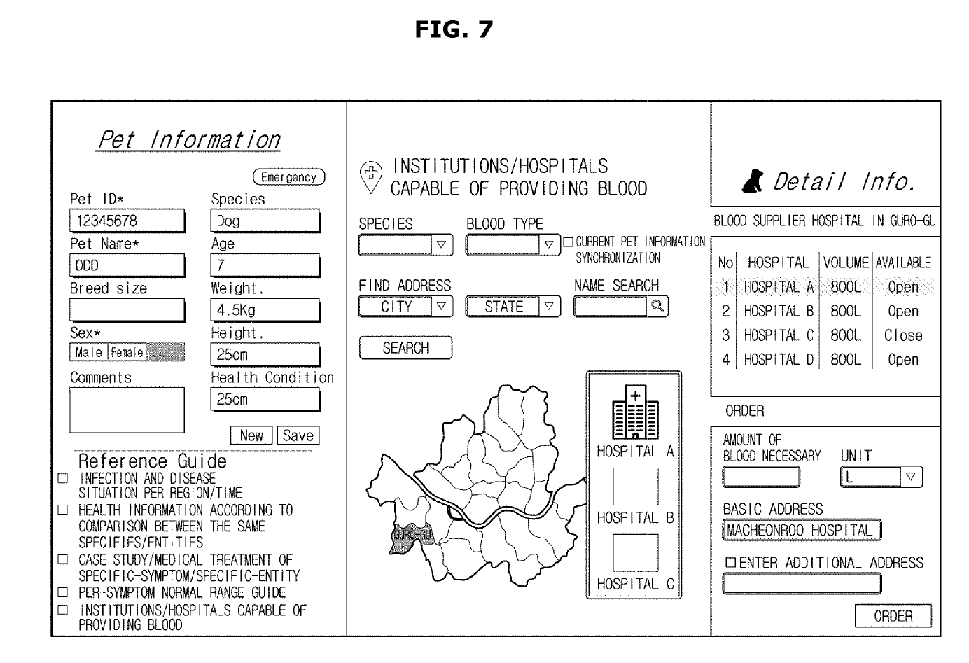

FIGS. 7 to 13 illustrate exemplary methods for displaying information about a target object and information about a blood supplier received from the blood management server apparatus through a terminal device according to an exemplary embodiment of the present disclosure.

The blood management server apparatus 100 may receive information about various target objects and information about the blood supplier from the information Tx/Rx apparatus 2, and may store the received information.

For example, the user may acquire target object information using the medical device 2b, or may input the target object information acquired through questions using various input devices. As described above, the input target object information may be stored in the server 2a of each institution or hospital, may be transmitted to and stored in the blood management server apparatus 100 over a wired communication network or a wireless communication network.

The blood management server apparatus 100 may transmit the stored information to the terminal device 3. The terminal device 3 may display information received from the blood management server apparatus 100 using graphical interfaces.

For example, the entire system screen structure for the blood management method may be displayed using the graphical interface as shown in FIG. 7. Referring to FIG. 8, the terminal device 3 may display unique information of a target object, physical information of a target object, institutions/companies capable of supplying blood, information about blood held by blood supplier companies/institutions, and information about blood-transfusion/blood-donation requests using the graphic interface. Therefore, the user can easily input his or her desired information using the input unit of the terminal device 3 through the entire system screen structure for the blood management method displayed on the terminal device 3.

Referring to FIGS. 8 to 13, the terminal device 3 may display at least one of statistical information of blood storage, per-region infection status information, per-time infection status information, cat's blood type and per-country ratio information, and dog's blood type and blood transfusion acceptance/denial information using graphical interfaces.

As described above, if transfusable blood for a blood recipient is needed, the request for searching for and using transfusable blood can be transferred to the blood server apparatus 100 through the input unit of the terminal device 3. In this case, when the user inputs the request for searching for and using transfusable blood, priority information can be established using the input unit of the terminal device 3. The input unit of the terminal device 3 may include at least one of a keyboard, a mouse, and a touch-type display. The terminal device 3 may display priority setting information thereon. The user may establish priority information through the input unit of the terminal device 3.

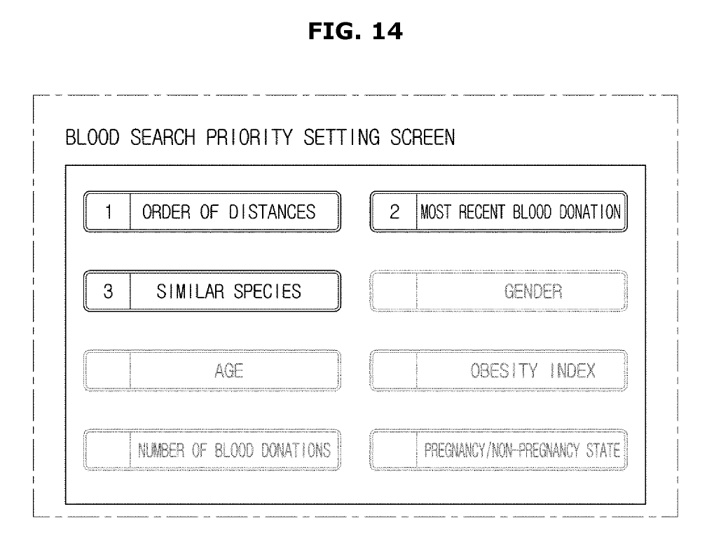

For example, as shown in FIG. 14, the terminal device 3 may output priority information of transfusable blood using a graphical interface.

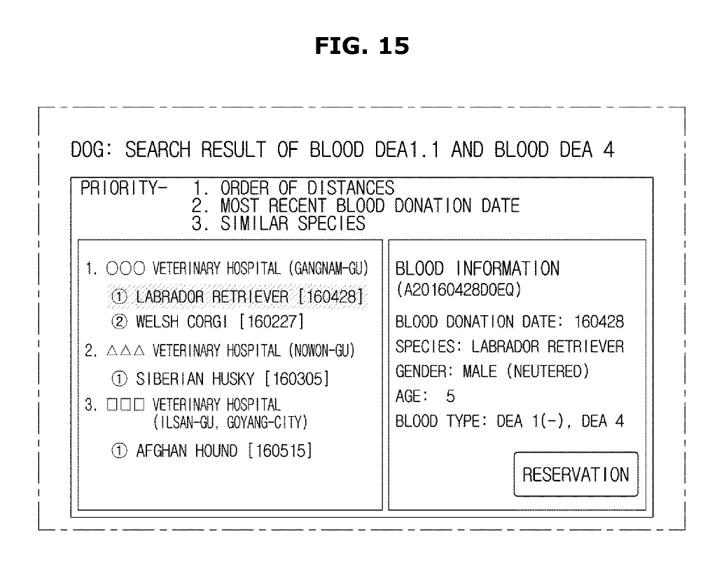

The user may input priorities of blood recipient information, transfusable blood information, and a search condition of transfusable blood through the input unit of the terminal device 3. As shown in FIG. 15, the terminal device 3 may arrange information entered through the input unit of the terminal device 3 according to priority information, and may display the arranged information.

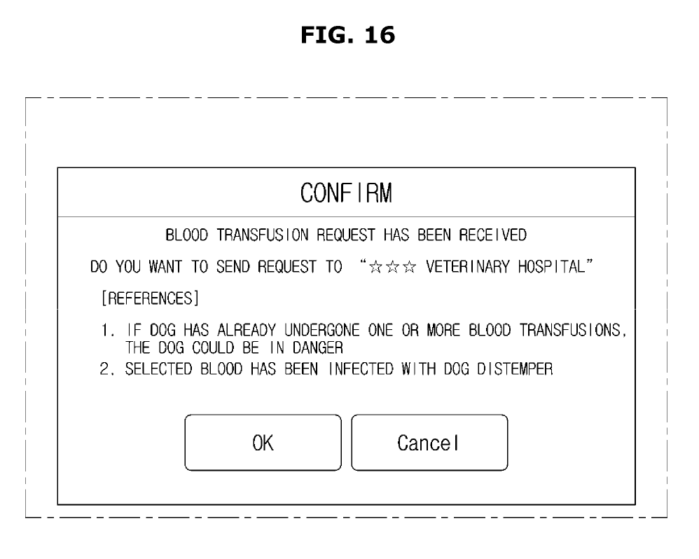

In addition, the user may transmit the request for searching and using transfusable blood to the blood management server apparatus 100 through the input unit of the terminal device 3. If the user inputs the request for searching for and using transfusable blood to the terminal device 3, the terminal device 3 may display information about the request for searching for and using transfusable blood as shown in FIG. 16.

Upon receiving the request for searching for and using transfusable blood from the terminal device 3, the blood management server apparatus 100 may search for information stored in the blood supplier DB 111, and may transmit the request for use of transfusable blood to the server 2a of the blood supplier having the transfusable blood.

The server 2a of the blood supplier may receive the request for use of transfusable blood from the blood management server apparatus 100. If the output device of the blood supplier receives the request for use of the transfusable blood from the server 2a of the blood supplier, the output device of the blood supplier may display the result of the request for use of the transfusable blood from the blood management server apparatus 100.

FIGS. 14 to 17 illustrate exemplary methods for displaying information about a blood transfusion request received from the blood management server apparatus through a terminal device according to an exemplary embodiment of the present disclosure.

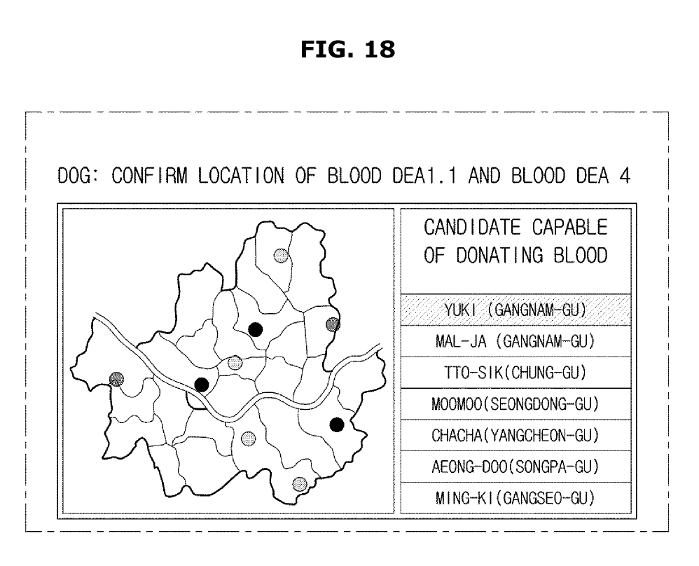

FIGS. 18 to 20 illustrate exemplary methods for displaying information about a blood donation request received from the blood management server apparatus through a terminal device according to an exemplary embodiment of the present disclosure.

Upon receiving the request for searching for transfusable blood from the user, the blood management server apparatus 100 may search for information stored in the blood supplier DB 111.

According to the search result, if a blood supplier having transfusable blood is not found, the blood management server apparatus 100 may search for blood donor's blood information stored in the target object DB 112, and may transmit the search result to the terminal device 3. The terminal device 3 may display the blood donor information found in the blood management server apparatus 3 using the graphical interface as shown in FIG. 18.

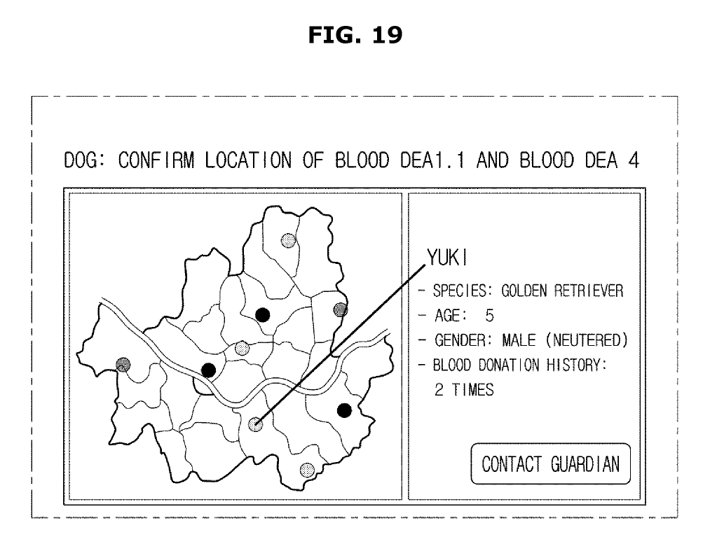

In addition, the blood server apparatus 100 may search for blood donor information stored in the target object DB 112, may search for a blood donor having transfusable blood, and may request blood donation from the blood donor. The blood management server apparatus 100 may transmit information about a blood donation request for the blood donor to the terminal device 3. The terminal device 3 may receive the blood donation request for the blood donor from the blood management server apparatus 100, and may display the received blood donation request using the graphical interface as shown in FIG. 19.

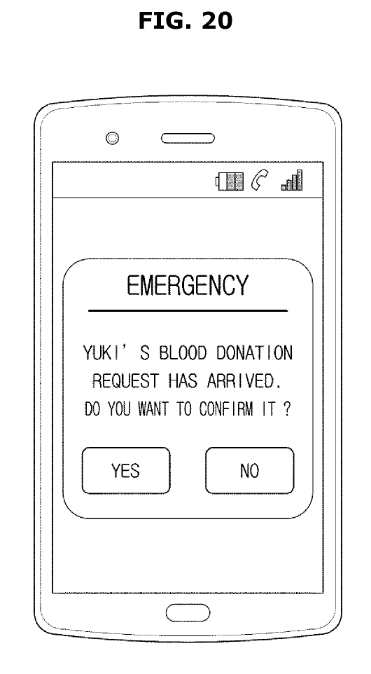

In this case, if a blood donor is a person, the blood management server apparatus 100 may transmit a blood donation request to a smartphone or a wearable device of the person. However, if a blood donor is an animal, the blood management server apparatus 100 may transmit a blood donation request of the corresponding animal to a smartphone or wearable device owned by a guardian of the corresponding animal. In this case, upon receiving a blood donation request for transfusable blood from the blood management server apparatus 100, the terminal device 3 may display the received blood donation request using the graphical interface as shown in FIG. 20.

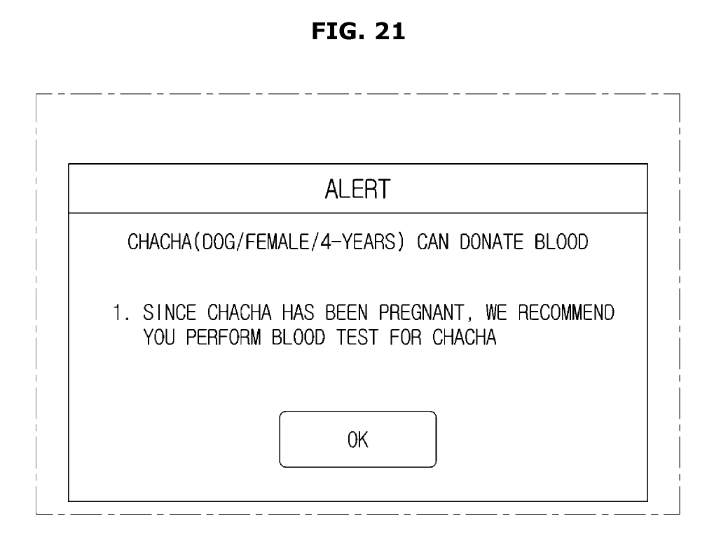

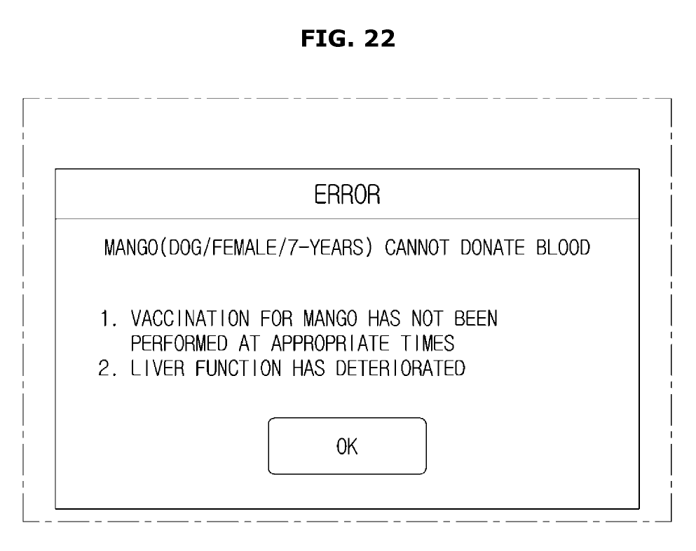

FIGS. 21 and 22 illustrate exemplary methods for displaying information about a blood donation decision result received from the blood management server apparatus through a terminal device according to an exemplary embodiment of the present disclosure.

The user may input information about the blood donor using the input unit of the terminal device 100. In addition, the user who uses the input unit of the terminal device 100 may transmit a request for determining whether blood donation of a blood donor is accepted or denied to the blood management server apparatus 100 on the basis of blood donor information.

The blood donor information entered by the user may be transferred to the blood management server apparatus 100 through a wired communication network or a wireless communication network.

The blood management server apparatus 100 may determine whether blood donation of a blood donor is accepted or denied using the received blood donor information and information stored in the target object DB 112. For example, the blood management server apparatus 100 may search for information stored in the target object DB 112, such that the blood management server apparatus 100 can determine whether blood donation is accepted or denied on the basis of past disease information, pregnancy history information, etc.

The blood management server apparatus 100 may transmit the decision result of blood donation acceptance/denial to the requesting terminal device 3.

The terminal device 3 may transmit the decision result of blood donation acceptance/denial from the blood management server apparatus 100 using the graphical interface, as shown in FIGS. 21 and 22.

The blood management method, the blood management server apparatus, and the blood management system according to the above exemplary embodiments of the present disclosure can acquire blood recipient information, can decide transfusable blood, and can transmit a blood transfusion request or a blood donation request to a blood recipient or a blood donor on the basis of presence or absence of transfusable blood.

The above-mentioned exemplary embodiments may be implemented in the form of a recording medium storing commands capable of being executed by a computer system. The commands may be stored in the form of program code. When the commands are executed by the processor, a program module is generated by the commands so that the operations of the described exemplary embodiments may be carried out. The recording medium may be implemented as a computer-readable recording medium.

The computer-readable recording medium includes all kinds of recording media storing data readable by a computer system. Examples of the computer-readable recording medium include a Read Only Memory (ROM), a Random Access Memory (RAM), a magnetic tape, a magnetic disk, a flash memory, an optical data storage device, etc.

As is apparent from the above description, a blood management method, a blood management server apparatus, and a blood management system according to the exemplary embodiments of the present disclosure can perform integrated management of information about blood transfusion objects (i.e., blood recipients) and blood donation objects (i.e., blood donors). The blood management method, the blood management server apparatus, and the blood management system according to the exemplary embodiments of the present disclosure can transfuse blood into a blood recipient by quickly sending a request for blood donation or a response to blood transfusion. In addition, the blood management method, the blood management server apparatus, and the blood management system according to the exemplary embodiments of the present disclosure can display operations of the blood management system using a graphical interface, resulting in greater user convenience.

Although a few exemplary embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. A blood management method comprising:
acquiring information about a blood recipient;
determining transfusable blood for the blood recipient based on the information about the blood recipient;
searching for the determined transfusable blood in a blood supplier database; and
transmitting a request for use of the transfusable blood to a blood supplier server of at least one searched blood supplier corresponding to the transfusable blood when the transfusable blood is found in the blood supplier database and transmitting a blood donation request to at least one terminal device when the transfusable blood is not found in the blood supplier database.

2. The blood management method according to claim 1, wherein the information about the blood recipient comprises at least one of current information and previous information about the blood recipient.

3. The blood management method according to claim 1, wherein the blood supplier database comprises blood supplier information about a blood supplier capable of providing the transfusable blood.

4. The blood management method according to claim 1, wherein the transmitting the request for use of the transfusable blood to the blood supplier server comprises:
receiving location information of a blood supplier from the blood supplier server of the at least one searched blood supplier;
determining distance information based on the location information; and
determining the blood supplier based on the distance information, and transmitting the request for use of the transfusable blood to a server of the determined blood supplier.

5. The blood management method according to claim 1, wherein the transmitting the request for use of the transfusable blood to the blood supplier server comprises:
transmitting a request for use of the transfusable blood to the blood supplier server of the at least one blood supplier according to predetermined priority information.

6. The blood management method according to claim 1, wherein the transmitting the blood donation request to the at least one terminal device comprises:
receiving location information from the at least one terminal device;
determining distance information based on t the location information; and
transmitting the blood donation request to the at least one terminal device based on the determined distance information.

7. The blood management method according to claim 1, wherein the transmitting the blood donation request to the at least one terminal device comprises:
transmitting the blood donation request to the at least one terminal device determined according to predetermined priority information.

8. The blood management method according to claim 2, wherein the current information comprises at least one of current health status information of the blood recipient, blood type information, species information, and identification (ID) information.

9. The blood management method according to claim 2, wherein the previous information comprises at least one of past disease information of the blood recipient, image diagnosis information, vaccination history information, blood test history information, pregnancy history information, blood transfusion history information, blood donation history information, and medicine and medical supplies prescription history information.

10. The blood management method according to claim 3, wherein the blood supplier information comprises at least one of location information of the blood supplier, information about an amount of blood held by the blood supplier, contact information, and blood status information.

11. The blood management method according to claim 1, further comprising:
displaying at least one of the acquired blood recipient information, information about the transfusable blood for the blood recipient decided based on the blood recipient information, information about a result of searching for the determined transfusable blood in the blood supplier database, information about a result of requesting use of the transfusable blood, and information about the result of the blood donation request.

12. The blood management method according to claim 11, wherein the displaying comprises:
arranging at least one of information about the transfusable blood for the blood recipient decided based on the blood recipient information, information about the result of searching for the transfusable blood in the blood supplier database, information about the result of requesting use of the transfusable blood, and information about the result of the blood donation request according to priority information; and
displaying the arranged information.

13. A blood management server apparatus comprising:
a receiver configured to receive information about a blood recipient;
a storage unit having a target object database and a blood supplier database configured to store the information about the blood recipient;
a controller configured to determine transfusable blood for the blood recipient based on the information about the blood recipient, and search for the determined transfusable blood in the blood supplier database; and
a transmitter configured to transmit a request for use of the transfusable blood to a blood supplier server of at least one searched blood supplier corresponding to the transfusable blood when the transfusable blood is found in the blood supplier database and transmit a blood donation request to at least one terminal device when the transfusable blood is not found in the blood supplier database.

14. The blood management server apparatus according to claim 13, wherein the information about the blood recipient comprises at least one of current information and previous information about the blood recipient.

15. The blood management server apparatus according to claim 13, wherein the blood supplier database comprises blood supplier information about a blood supplier having the transfusable blood.

16. The blood management server apparatus according to claim 14, wherein the current information comprises at least one of current health status information of the blood recipient, blood type information, species information, and identification (ID) information.

17. The blood management server apparatus according to claim 14, wherein the previous information comprises at least one of past disease information of the blood recipient, image diagnosis information, vaccination history information, blood test history information, pregnancy history information, blood transfusion history information, blood donation history information, and medicine and medical supplies prescription history information.

18. The blood management server apparatus according to claim 15, wherein the blood supplier information comprises at least one of location information of the blood supplier, information about an amount of blood held by the blood supplier, contact information, and blood status information.

19. A blood management system comprising:
a blood management server apparatus configured to receive information about a blood recipient, determine transfusable blood for the blood recipient based on the information about the blood recipient, search for the determined transfusable blood in a blood supplier database, request use of the transfusable blood from a server of the blood supplier by transmitting a request for use of the transfusable blood to the blood supplier server when the transfusable blood is found in the blood supplier database, and request blood donation from at least one terminal device by transmitting a blood donation request to at least one terminal device when the transfusable blood is not found in the blood supplier database; and
at least one terminal device configured to display information about at least one of the request for use of the transfusable blood and the blood donation request for the transfusable blood upon receiving the request for use of the transfusable blood and the blood donation request from the blood management server apparatus, or display at least one of information about the blood recipient and information about the blood supplier database.

20. The blood management system according to claim 19, wherein the information about the blood recipient comprises at least one of current information and previous information about the blood recipient.
